(19) United States
(12) Patent Application Publication
(10) Pub. No.: US 2023/0122037 A1
(43) Pub. Date: Apr. 20, 2023

(54) RIP GUIDE

(71) Applicant: Affinity Tool Works, LLC, Troy, MI (US)

(72) Inventors: David Thimm, Plymouth, MI (US); Will Koederitz, Royal Oak, MI (US); Mike Ursell, Bloomfield Hills, MI (US); Connor Ursell, Bloomfield Hills, MI (US); Rod Bonham, Decatur, TX (US); Ken Neilson, Rochester Hills, MI (US); Ryan Spaulding, St. Clair, MI (US); Alex Morck, Clarkston, MI (US); Mark Cross, Marysville, MI (US)

(21) Appl. No.: 17/966,765

(22) Filed: Oct. 14, 2022

Related U.S. Application Data
(60) Provisional application No. 63/256,289, filed on Oct. 15, 2021.

(51) Int. Cl. B27B 27/02

(52) U.S. Cl. CPC B27B 27/02

(57) ABSTRACT

A power tool guide having a tool plate adapted to receive a power tool. The plate has a power tool engagement clamp to engage a power tool and connect the power tool to said tool plate without the use of tools. The tool plate has opposed channels and a control lock. A support base has opposed guide rails, each of the guide rails has first and second ends. The tool plate has opposed channels that are removably mounted upon the support base opposed guide rails between the first and second ends. The channels allow the tool plate to slide upon opposed guide rails and to be easily removed from the rails. The control lock locks the tool plate with respect to the support base at a desired position along the opposed guide rails a spaced distance from the first and second ends. The support base has an edge extending from at least one of the guide rails adjacent one of the first and second ends. The edge engages a side of the workpiece to slide along the side of the workpiece to be moved along the workpiece with the tool positioned a spaced distance from the side of the workpiece.

### CROSS-REFERENCE TO RELATED APPLICATIONS

This application claims the benefit of U.S. Provisional Application Ser. No. 63/256,289, filed Oct. 15, 2021, which is incorporated herein by reference in their entirety.

### TECHNICAL FIELD

This invention relates generally to power tools for use in wood working for example and more particularly to rip guides.

### BACKGROUND OF THE INVENTION

Power tool guides of various types are common, particularly with respect to working applications. One type of guide is a rip guide which allows for straight cuts, and repetitive cuts of a piece of material.

Typical rip guides have an extension arm that connects to the power tool, such as for example, a circular saw. The free end of the extension has some type of straight edge that guides the saw at a spaced distance from the edge of the material. In this way, the saw can cut or rip sheet goods, like plywood down to a desired size.

One type of rip guide is a single rod bent at one end with a plate welded to the bent portion. The rod is attached to the power tool at a desired position from the plate. The plate slides along the edge of the sheet material to make a straight cut for example.

Another type uses a plate to which the power tool is attached, a straight edge to which the plate is attached, and a rip handle attached at the end of the straight edge. These operate like the simple bent rod type, but also allow the straight edge to be used for other purposes, other than as a rip guide.

A problem with both above rip guides is the potential for misalignment and racking. Also, set up can be time consuming, particularly attaching the rod to the saw or the plate to the saw. Adjusting the width of the cut can also be difficult since it typically requires using a tape measure to set the desired positioned on the rod or straight edge and then clamping the saw in place on the rod or straight edge.

What is needed is a rip guide that makes it quick and easy to accurately rip sheet goods down to size. Whether you need to make one, or multiple cuts, the rip guide needs to prevent racking and misalignment and have an ergonomic handle that provides ultimate control. The rip guide also needs to have a quick system for attaching the power tool. It would also be desirable to fit both left and right-handed circular saws and be compact and portable for easy set up. The rip guide should also have a easy adjustment to set the position of the power tool with respect to the edge of the material that requires ripping.

### SUMMARY OF THE INVENTION

The present invention solves the problems of known tool guides. The present invention has a tool plate adapted to receive a power tool. The plate has a power tool engagement clamp to engage a power tool and connect the power tool to said tool plate without the use of tools. The tool plate has opposed channels and a control lock.

A support base has opposed guide rails, each of the guide rails has first and second ends. The tool plate has opposed channels that are removably mounted upon the support base opposed guide rails between the first and second ends. The channels allow the tool plate to slide upon opposed guide rails and to be easily removed from the rails.

The control lock locks the tool plate with respect to the support base at a desired position along the opposed guide rails a spaced distance from the first and second ends. The support base has an edge extending from at least one of the guide rails adjacent one of the first and second ends. The edge engages a side of the workpiece to slide along the side of the workpiece to be moved along the workpiece with the tool positioned a spaced distance from the side of the workpiece.

The tool guide includes a tool engagement clamp having a housing that moves with respect to said tool plate. A shoe pad is reciprocally mounted within the housing adapted to engage the tool and a locking pad engages the tool plate to lock the tool engagement clamp with respect to the tool plate.

These and other features and advantages of this invention will become more apparent to those skilled in the art from the detailed description of a preferred embodiment. The drawings that accompany the detailed description are described below.

### BRIEF DESCRIPTION OF THE DRAWINGS

FIG. 1 is a perspective view of the rip guide of the present invention with a circular saw attached.

FIG. 2 is a top view of the plate.

FIG. 3 is a bottom view of the plate.

FIG. 4 is a partial view of FIG. 3.

FIG. 5 is a partial view of FIG. 3.

FIG. 6 is a partial cutaway view of the control lock.

FIG. 7 is a partial cutaway view of the control lock.

FIG. 8 is a partial perspective view of the rip guide.

FIG. 9 is a partial perspective view of the plate and engagement clamp.

FIG. 10 is a perspective view of the bottom of the engagement clamp.

FIG. 11 is a partial perspective view of the plate and the bottom of the engagement clamp.

FIG. 12 is a partial perspective view of the engagement clamp.

FIG. 13 is a partial perspective view of the engagement clamp.

FIG. 14 is a partial perspective view of the rail.

FIG. 15 is a perspective view of the rip guide base, rails, and cross member.

FIG. 16 is a partial perspective view of the rip guide base from the underside.

FIG. 17 is a perspective view of the rip guide base, rails, and cross member.

FIG. 18 is an exploded view from a first side of a further embodiment of an engagement clamp.

FIG. 19 is an exploded view from a second side of a further embodiment of an engagement clamp.

FIG. 20 is a cutaway view of the engagement clamp of FIGS. 18 and 19 in the locked position.

FIG. 21 is a cutaway view of the engagement clamp of FIGS. 18 and 19 in the unlocked position.

### DETAILED DESCRIPTION OF A PREFERRED EMBODIMENT

The rip guide of the present invention is generally shown at 10. The rip guide 10 of the present invention is used with power tools, such as circular saws, jigsaws etc. The illustrations and description refer to a circular saw, but it is not intended to limit the scope of the invention. The rip guide 10 includes a rip guide base 12, oppose guide rails 14 and 16, a cross number 18 and a tool plate 20. Tool plate 20 sets on top of and slides along guide rails 14 and 16. It should be appreciated that one rail 14 could be used if desired, however opposed rails 14 and 16 are more stable and provide more flexibility in use of the guide rail 10.

In use, a power tool such as a circular saw is mounted on the plate 20. The rip guide base 12 is positioned against the edge of the material to be cut. Plate 20 is positioned over the rails 14 and 16, can be slid along the rails 14 and 16 and then locked in place at the desired width of the rip cut. The plate control and lock 30 can be used to incrementally adjust the plate 20 along the rails 14 and 16 and lock the plate 20 with respect to the rails 14 and 16. In this way, precise rip cuts can be achieved. The rip guide base 12 is then slid along the edge of the material with a circular saw making the desired cut.

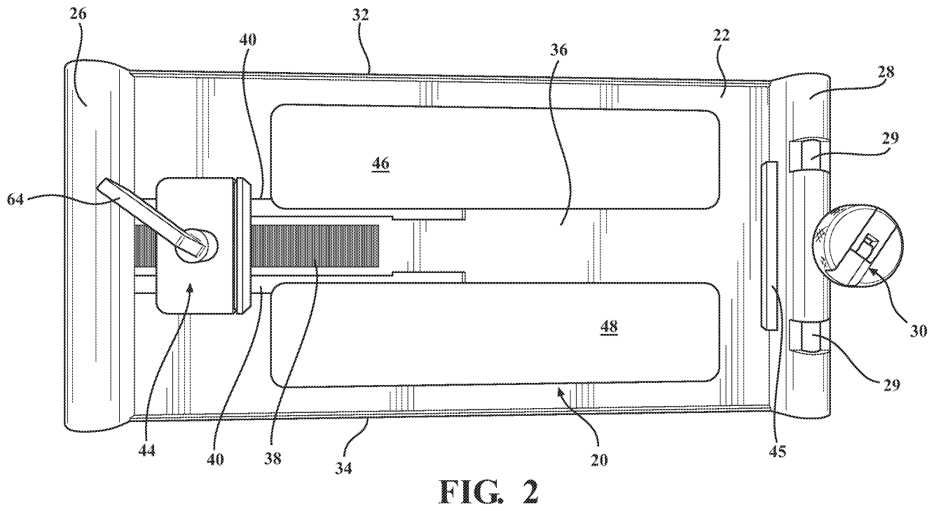

With respect to FIG. 2, the plate 20 will be described in greater detail. The plate 20 has a top surface 22 and opposed end channels 26 and 28. The end channel 28 includes windows 29 which open to the top of the rails 14 and 16, which have a scale in for example metric or English measurements. This allows for precise and accurate adjustment of the plate 20 to make accurate rip cuts. It should be understood that the scale can be on one or both rails 14 and 16. In the disclosed embodiment, the plate 14 has an index line 27 that matches factory saw markings on the plate 14 to facilitate accurate alignment.

In the disclosed embodiment, the plate 20 has opposed raised outer edges 32 and 34. The raised outer edges 32 and 34 allow the shoe 41 of the saw to abut one or other of the edges 32 and 34 to properly align the saw on the plate 20. A middle support 36 extends down the center of the plate 20 creating two blade openings 46 and 48 to receive the blade and guard of the saw. The pair of openings 46 and 48 allow the saw to be mounted to the plate 20 for right-handed and left-handed use.

The middle support 36 has a serrated surface 38 on one end and is undercut at 40 and 42 on that same end. A tool engagement clamp 44 is mounted within the undercuts 40 and 42 and slides along the undercuts 40 and 42. The clamp 44 engages the shoe 41 of the saw to clamp it to the plate 20. A slot 45 is formed opposite the clamp 44. The opposite side of the shoe is inserted into slot 45 and held in the slot 45 by clamp 44. As illustrated, clamp 44 has a locking or clamping handle 64 that locks the clamp 44 in place when the desired position is established.

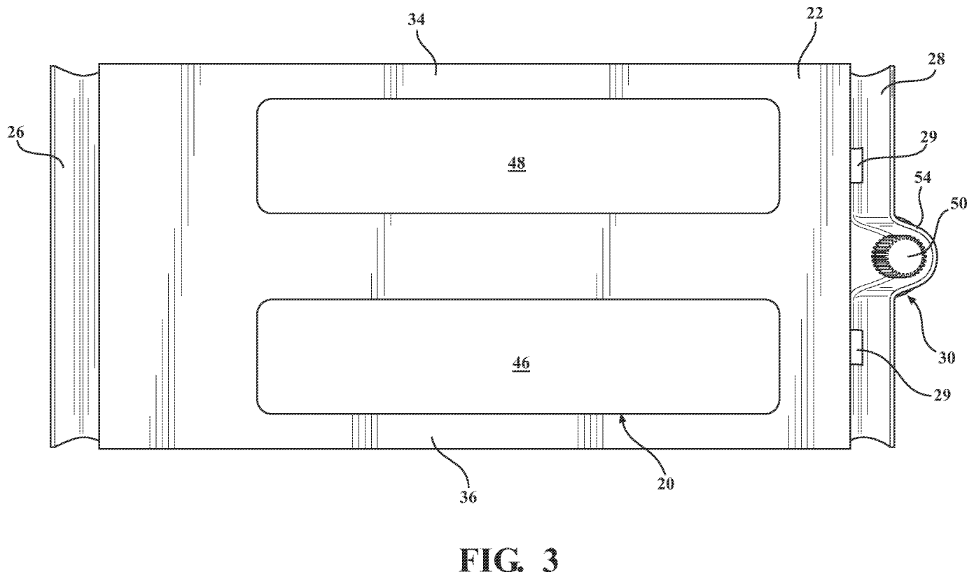

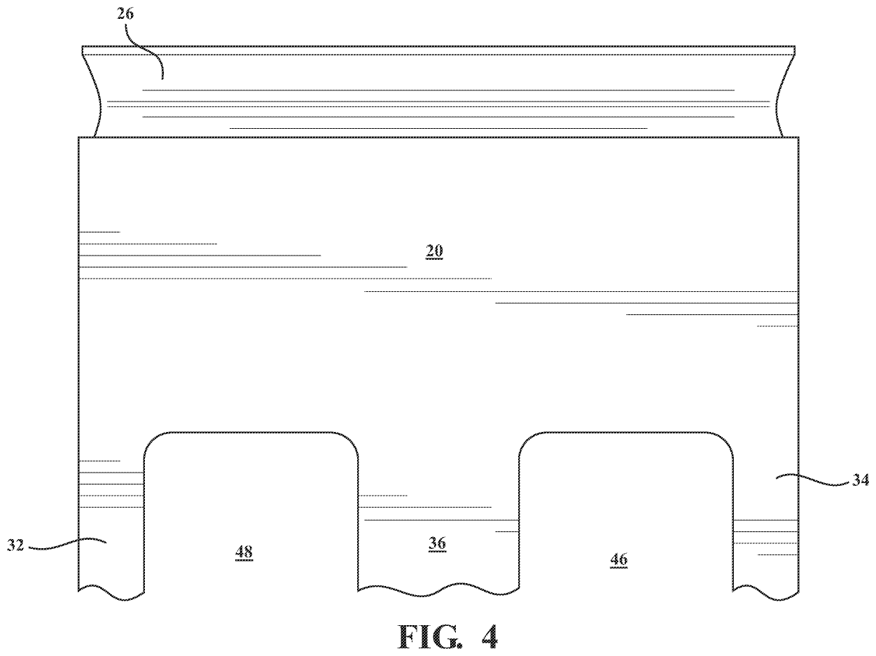

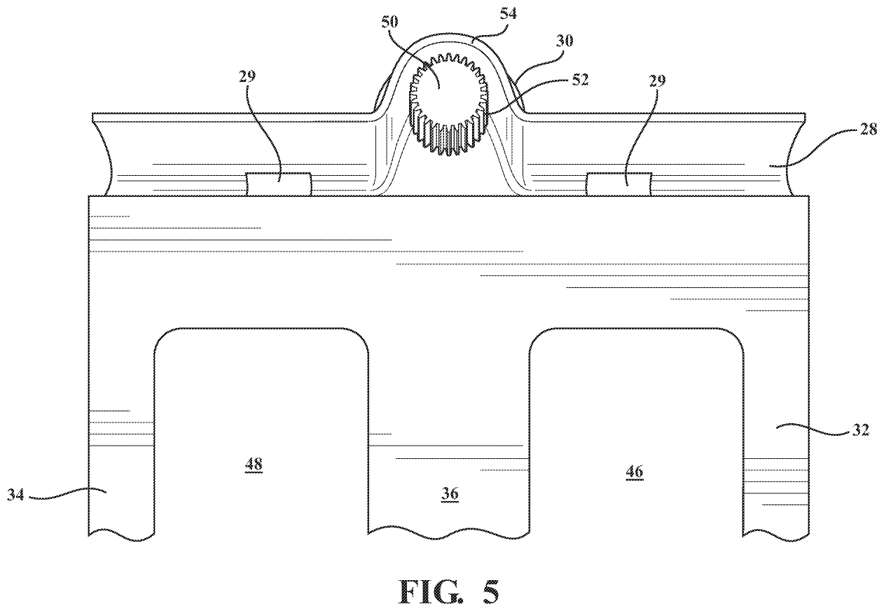

With reference to FIGS. 3, 4, and 5, the underside of the plate 20 is shown. As shown, the channels 26 and 28 have the same general profile as the rails 14 and 16. It will be understood that the rails 14 and 16 and channels 26 and 28 could have different shapes, such as square, oblong, triangular, etc. The channels 26 and 28 are adapted to slide along the rails 14 and 16 to allow proper adjustment of the plate with respect to the base 12 to ensure proper ripping.

The plate lock 30 has a locking wheel 50 mounted for rotation in a housing 54. As illustrated, the housing 54 is integrally formed with the end channel 28. The locking wheel 50 has control engagement teeth 52 that engage with the guide engagement teeth 56 on the rails 14 and 16. The mating teeth 52 and 56 allow for precise adjustment of the plate 20 along the guide rails 14 and 16. As disclosed, the wheel 50 is generally conical for easier mating with the guide engagement teeth 56. The mating teeth 52 and 56 also allow for positive locking of the plate 20 with respect to the guide rails 14 and 16.

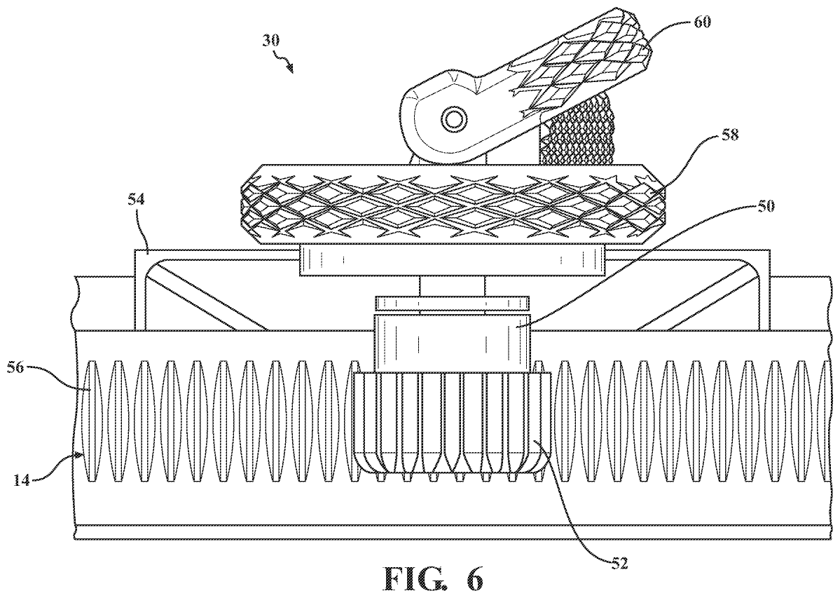

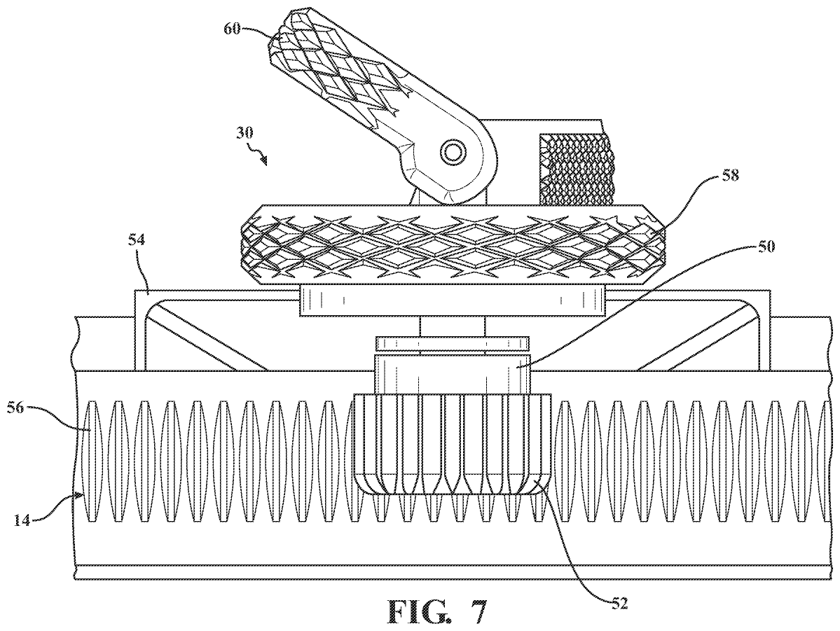

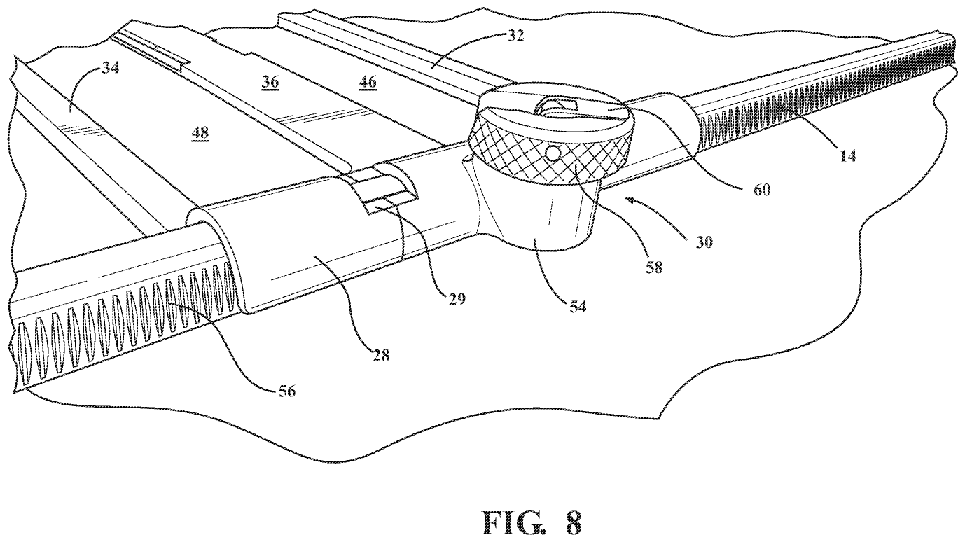

As illustrated in FIG. 6, the plate control lock 30 includes control knob 58 and lock 60. The lock 60 prevents movement of the knob 58 when it is rotated in one direction and allows the knob 58 to rotate when it is rotated in the opposite direction. When the knob 58 is locked, as shown in FIG. 7, the wheel 50 is raised into engagement with the housing or body 54 preventing rotation of the wheel 50 and sliding movement of the plate 20 on the rails 14 and 16. But, the plate 20 can be easily removed from the rails 14 and 16 with the knob 58 locked. When the knob 58 is unlocked, as shown in FIG. 6, the wheel 50 is lowered out of engagement with the housing 54 allowing rotation of the wheel 50 and sliding movement of the plate 20 on the rails 14 and 16 and precise location.

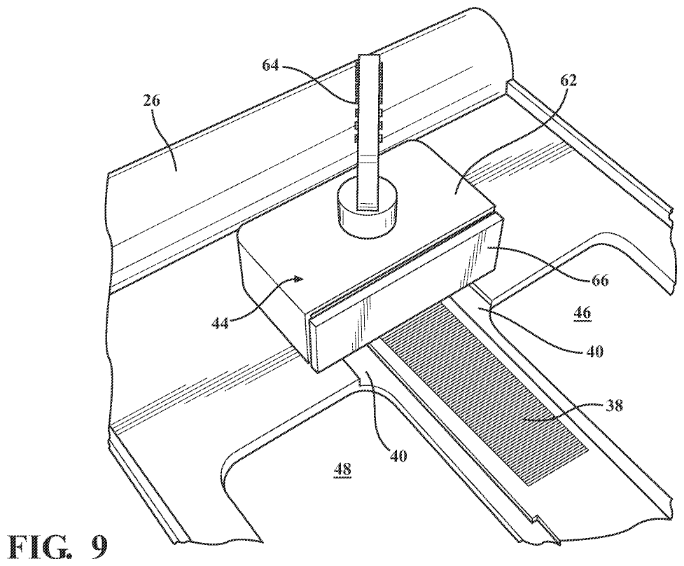

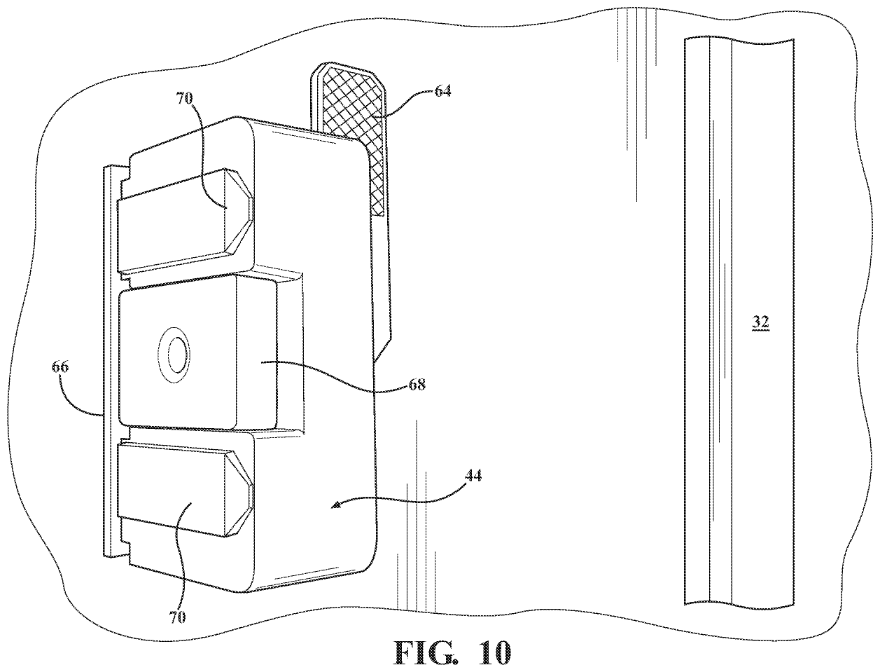

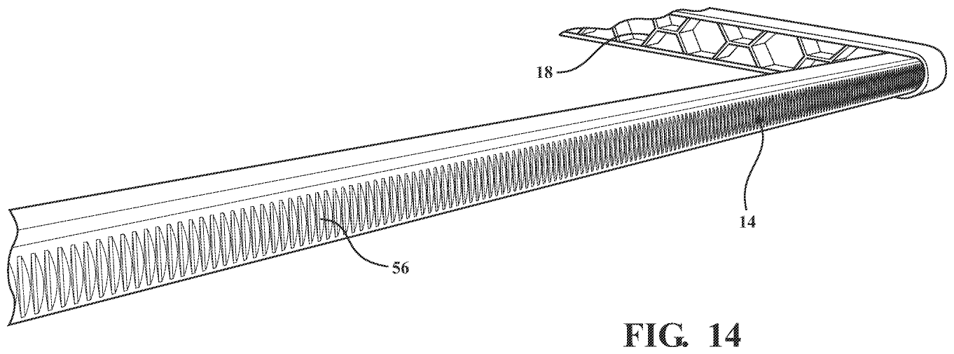

With reference to FIGS. 9 through 14, power tool engagement clamp 44 will be described. The clamp 44 is unique in that no tools are required to clamp the power tool and the clamp 44 provides a unique positive lock. The clamp 44 has a block 62 which contains a shoe pad 66 that engages the shoe of the saw and a locking pad 68, see FIG. 10, that engages the serrated surface 38 to lock the clamp 44 with respect to the plate 20. To obtain a positive lock, the surface of locking pad 68 is serrated to mate with the serrated surface 38. A locking handle 64 controls both the shoe pad 66 and the locking pad 68.

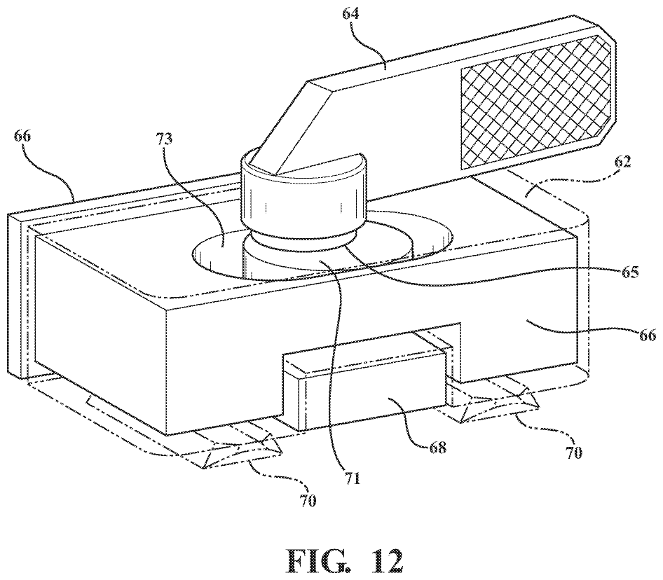

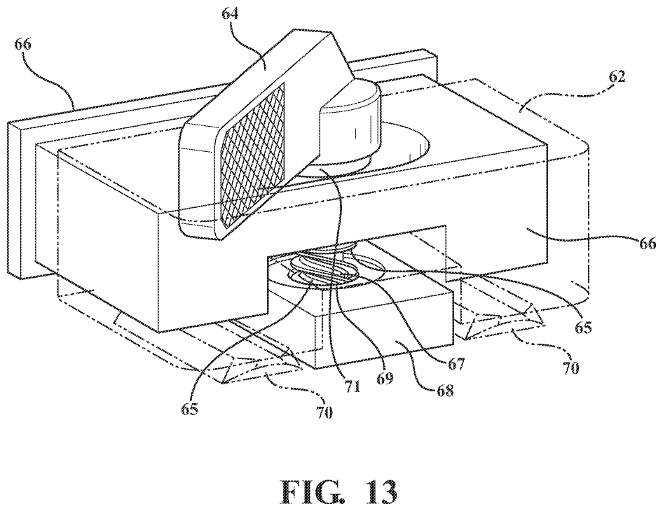

With reference to FIGS. 12 and 13, the handle 64 is attached to a rod 65 that extends through the block 62 and the shoe pad 66. The distal end 67 if the rod 65 is threaded and received within a treaded cavity 69 in the locking pad 68. When the handle 64 is rotated, the pad 68 is either raised or lowered. In the lowered position, the locking pad 68 is locked against the serrated surface 38.

A cam 71 is mounted on the rod 65 for rotation with the rod 65. The cam 71 is mounted within an oblong cavity 73 in the shoe pad 66. When the handle 64 is rotated, the cam 71 engages the walls of cavity 73 to force the shoe pad 66 into and out of block 62.

In operation, the handle 64 is rotated to move the shoe pad 66 against the shoe 41 while simultaneously forcing the locking pad 68 against the serrated surface 38 to clamp the tool to the plate 20.

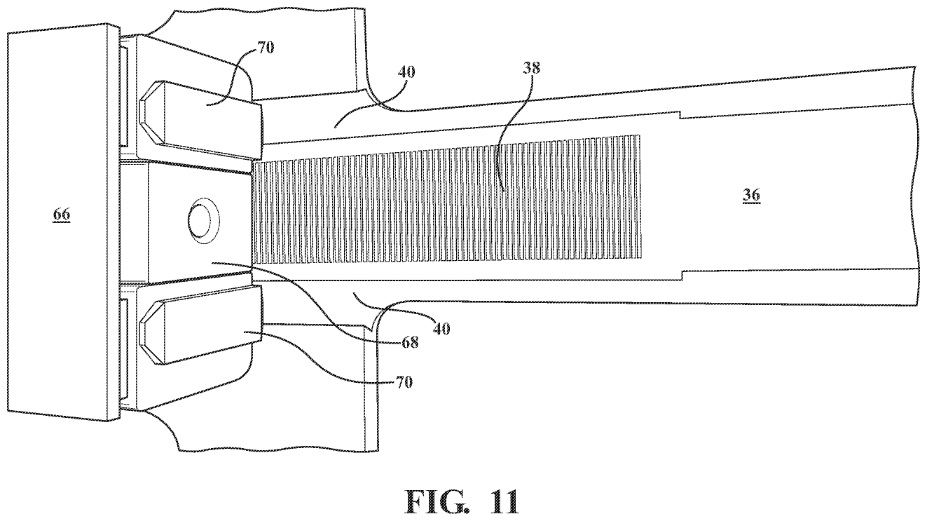

The block 62 has a pair of wedges 70, see FIG. 11, that mate within the undercuts 40. The wedges 70 and undercuts 40 provide for precise sliding of saw shoe engagement clamp 44 along the surface 22. It will be appreciated by those of ordinary skill in the art that many different mating arrangements could be used for example a t-shaped extension and slot, a pin and slot, etc.

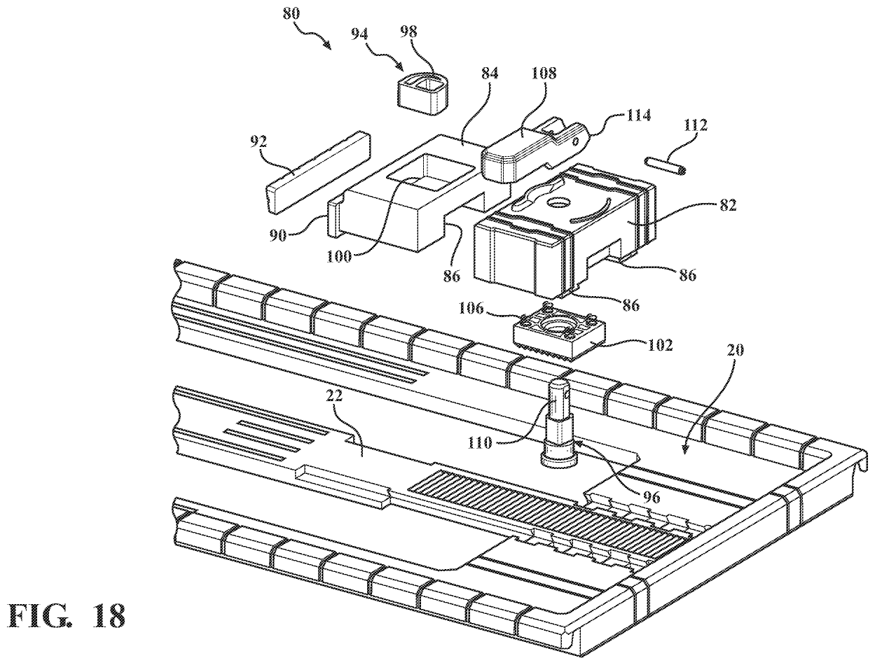

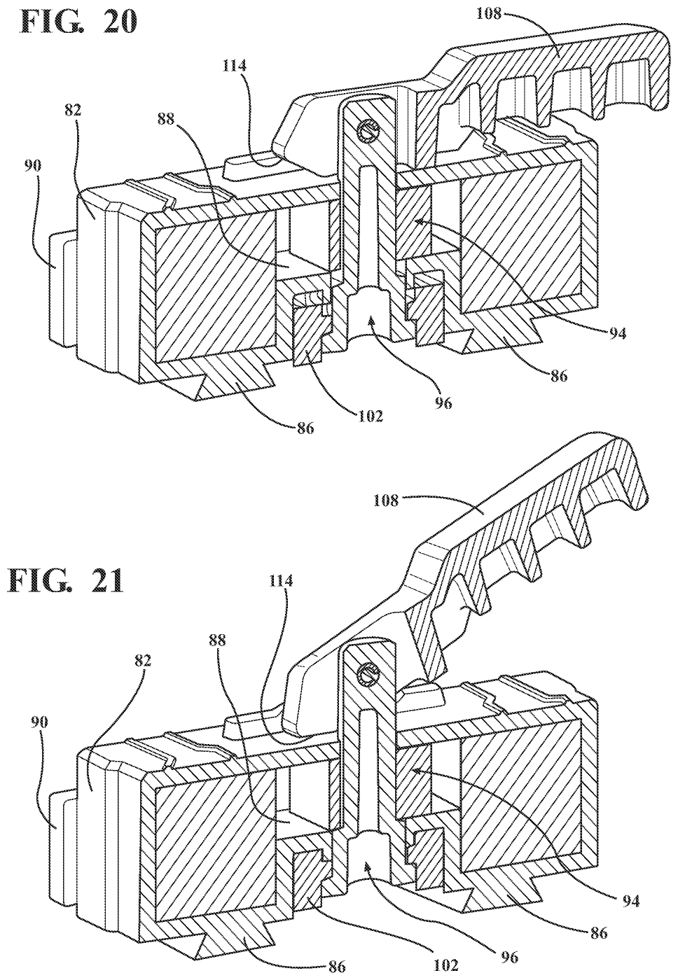

With reference to FIGS. 18 through 21, a second embodiment of the power tool clamp 80 will be described. Clamp 80 moves with respect to the plate 20 to engage the saw shoe 41. The clamp 80 has a housing 82 which houses a reciprocating engagement member 84. The housing 82 includes feet 86 that mate within undercuts 40 to retain the clamp 80 on the plate 20.

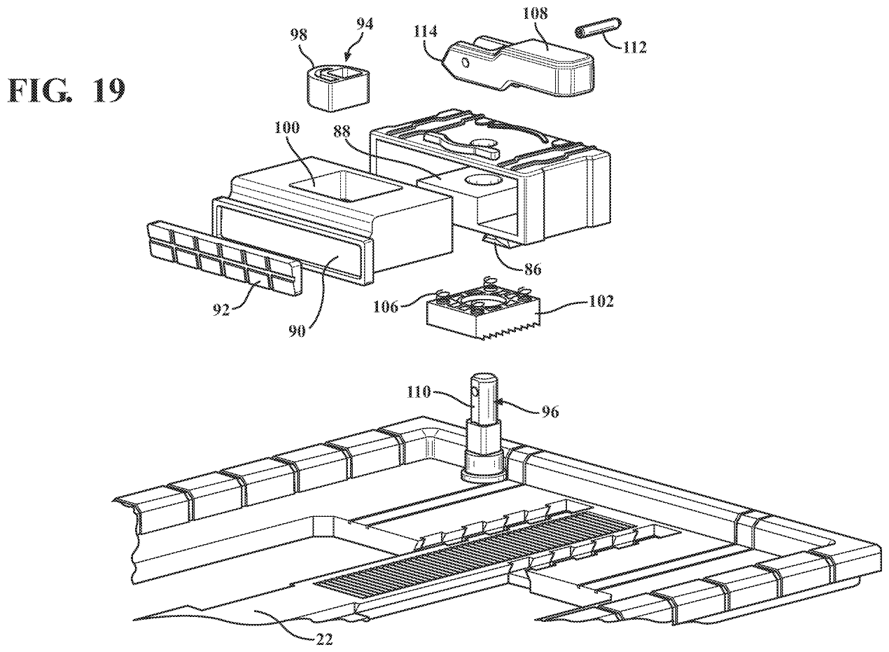

The reciprocating engagement member 84 is illustrated with an opening 86 that receives an alignment protrusion 88, see FIG. 19. The alignment protrusion 88 aligns the reciprocating engagement member 84 as it reciprocates within the housing 82. Reciprocating engagement member 84 has a front face which is illustrated with an optional flexible surface 92 to facilitate engagement with the saw shoe 41.

A drive key 94 is mounted to a control rod 96. The drive key 94 is illustrated with a semi-circular side surface 98. The drive key 94 mounts within a cavity 100 in the reciprocating engagement member 84. The control rod 96 rotates which causes the key 94 to rotate in cavity 100 to reciprocate the reciprocating engagement member 84 with respect to housing 82.

A position stop or lock plate 102 is mounted to the control rod 96. The plate 102 has teeth or serrations 104 that engage with mating teeth or serrations 38 in the surface 22. The plate 102 has biasing members 106 that bias the serrations 104 on plate 102 into engagement with the serrations 38 in surface 22. As illustrated, the biasing members 106 are small coil springs, but could be any other type of biasing member, such as a leaf spring, rubber insert, etc. When engaged, the mating serrations prevent the power tool clamp 80 from moving with respect to the surface 22.

A handle 108 is pivotally attached to the free end 110 of the control rod 96 by a pin 112. The handle 108 has a cam surface 114 and when the handle 108 is rotated, the cam surface 114 engages that housing 82 to reciprocate the control rod 96 and raise and lower the lock plate 102. When the handle 108 is raised, the control rod 96 reciprocates raising the plate 102 which disengages the serrations 104 from the serrations 38 in the surface 22 allowing the power tool clamp 80 to move with respect to base 29.

In use, the power tool clamp 80 is moved with respect to surface 22 into engagement with the saw shoe 41. The handle 108 is raised to disengage the serrations 104 from the serrations 38. Once the power tool clamp 80 is positioned against the shoe 41, the handle 108 is lowered to reengage the serrations 104 and 38. The handle 108 is then rotated to rotate drive key 94 in the cavity 100 forcing the reciprocating engagement member 84 into positive engagement with the shoe 41 to lock the shoe 41 into the plate 20. At this point the saw shoe 41 is locked into the plate 20. To remove the shoe 41, the steps are reversed.

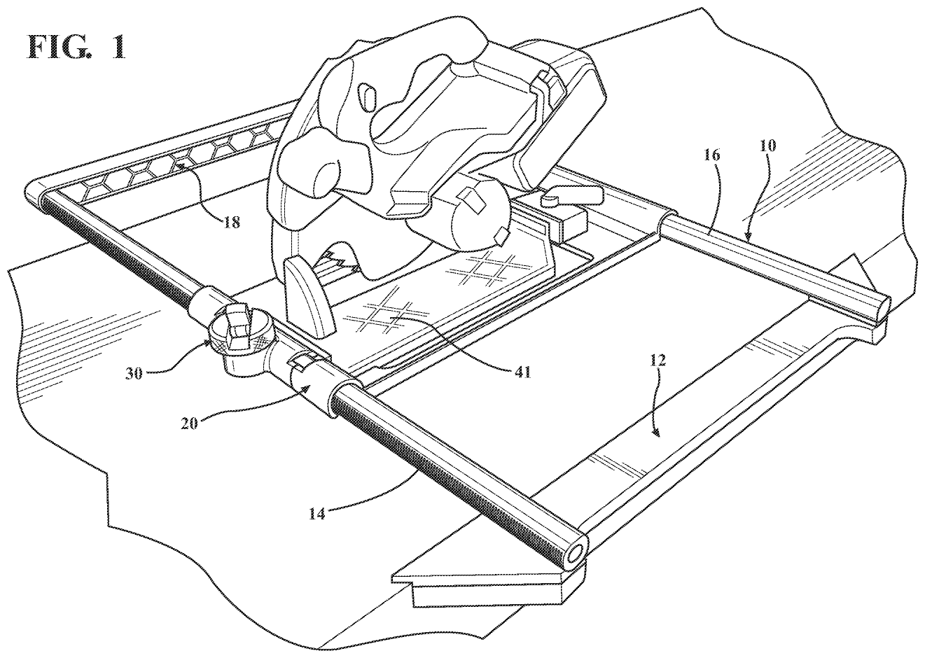

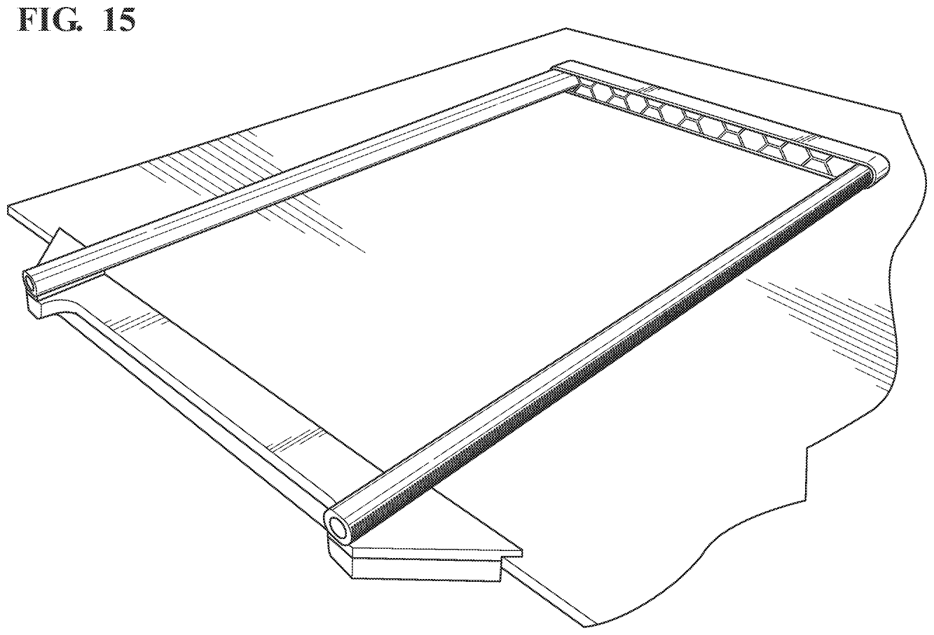

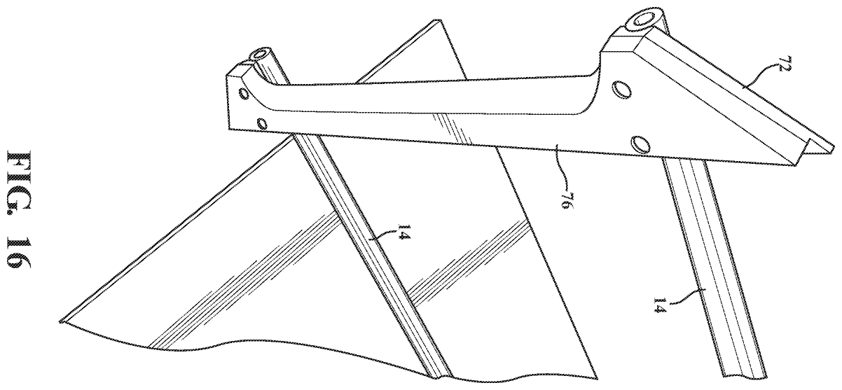

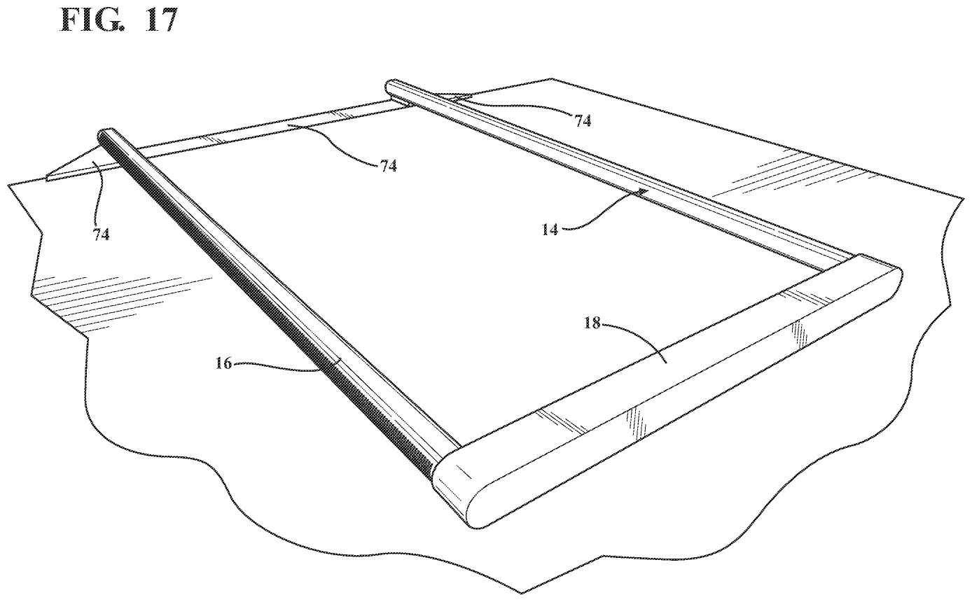

With reference to FIGS. 1, 14 through 17, the rip guide base 12 will be described. As illustrated, rip guide base 12 as illustrated has end wings or lips 72, an upper plate 74 and lower plate 76. The wings 72 extend inwardly towards the plate 20. The wings 72 engage the top of the work surface or material. The upper plate 74 provides strength to the rip guide base 12 and the overall rip guide 10. In the disclosed embodiments, the wings 72, upper plate 74 and the rails 14 and 16 are made of aluminum. The lower plate 76 as disclosed is made of plastic. This plate 76 engages the edge of the workpiece. The wings 72 support the rip guide 10 on the work surface or material and the lower plate 76 engages the workpiece edge for an accurate rip cut.

In use, the tool is mounted to the plate 20. The front of the shoe 41 is inserted into slot 45. One side of the shoe 41 is positioned against one of the outer edges 32 or 34. The blade of the saw extends through one of the openings 46 or 48. The shoe engagement clamp 44 is slid into engagement with the shoe 41. The locking handle 64 is then rotated to force locking pad 68 into engagement with serrated surface 38 and shoe pad 66 into engagement with the shoe to lock the saw to the plate 20.

The rip guide base 12 is then positioned against the edge of the material. The plate 20 is then slid along rails 14 and 16 to the desired position. Control knob 58 can be rotated for precise adjustment with the scale appearing through the windows 29. When the desired position is achieved, the lock 60 is engaged. The rip guide 10 can then be moved along the work surface to rip the material.

When the material is ripped, the ripped guide 10 can be repositioned at the same side of the material where the initial rip was started, and another rip cut can be made. Alternatively, the saw and plate 12 can be raised off the rails 14 and 16 rotated and replaced on the rails 14 and 16. When repositioned, another rip cut can be started from the side of the material where the previous cut ended. The locking wheel 50 easily mates with the guide engagement teeth 56. In this way multiple efficient rips can be made from both sides of the material.

The foregoing invention has been described in accordance with the relevant legal standards, thus the description is exemplary rather than limiting in nature. Variations and modifications to the disclosed embodiment may become apparent to those skilled in the art and do come within the scope of the invention. Accordingly, the scope of legal protection afforded this invention can only be determined by studying the following claims.

We claim:

1. A power tool guide comprising:
a tool plate adapted to receive a power tool, said plate having a power tool engagement clamp adapted to engage a power tool and connect the power tool to said tool plate;
said tool plate having opposed channels and a control lock;
a support base having opposed guide rails, each of said guide rails having first and second ends, said tool plate opposed channels being removably mounted upon said support base opposed guide rails between said first and second ends, said channels allowing said plate to slide upon said opposed guide rails,
said control lock locking said tool plate with respect to said support base at a desired position along said opposed guide rails a spaced distance from said first and second ends,
said support base having an edge extending from at least one of said guide rails adjacent one of said first and second ends, said edge being adapted to engage a side of the workpiece and to slide along the side of the workpiece;
whereby said tool plate is positioned upon said support base, said tool plate is locked a spaced distance from said first and second ends, said support base is then moved along said workpiece with the tool positioned a spaced distance from the side of the workpiece.

2. The power tool guide of claim 1, wherein said tool engagement clamp includes a housing that moves with respect to said plate;
a shoe pad reciprocally mounted within said housing adapted to engage the tool; and
a locking pad adapted to engage the tool plate to lock the tool engagement clamp with respect to said tool plate.

3. The power tool guide of claim 2, further including a locking handle for controlling said shoe pad and the locking pad, said handle is attached to a rod that extends through said shoe pad, said rod has a distal end and a proximal end, said distal end of said rod is threaded and received within a treaded cavity in said locking pad wherein said handle is rotated, said locking pad in a raised position or a lowered position, said raised position allows said power tool engagement clamp to move with respect to said plate, and when in said lowered position, said power tool engagement clamp is locked with respect to said tool plate.

4. The power tool guide of claim 2, further including a cam mounted on said rod for rotation with said rod;
said shoe pad includes an oblong cavity defined by walls, said cam is mounted within said oblong cavity in said shoe pad, rotation of said handle causes said cam to engage said walls of said cavity to force said shoe pad into and out of said housing,
whereby said handle is rotated to move said shoe pad against the shoe while simultaneously forcing said locking pad against said tool plate to lock said power tool engagement clamp against said plate.

5. The power tool guide of claim 2, wherein said tool plate includes a pair of undercuts, said housing includes a pair of wedges, said wedges mate with said pair of undercuts to provide precise movement of said power tool engagement clamp with respect to said tool plate.

6. The power tool guide of claim 2, wherein said tool plate includes a first serrated surface and said locking pad includes a second serrated to mate with said first serrated surface to provide a positive lock between said locking pad and said tool plate.

7. The power tool guide of claim 1, wherein said control lock includes a body and a control member mounted for rotation with respect to said body, said control member has control lock teeth;
said guide rails include mating guide teeth that engage with said control lock teeth;
said mating control lock teeth and said guide teeth provide precise adjustment of the tool plate along said guide rails and provide positive locking of the tool plate with said guide rails.

8. The power tool guide of claim 7, wherein the said control lock includes a control wheel and lever, said lever prevents movement of said control wheel when said lever is rotated in one direction and allows rotation of said wheel when said lever it is rotated in the opposite direction;
said wheel is locked when said wheel is raised into engagement said body, preventing rotation of the wheel, said wheel unlocked when disengaged from said body allowing rotation of said wheel and sliding movement of said tool plate on said rails.

9. The power tool guide of claim 1, wherein said tool engagement clamp includes a housing and a reciprocating engagement member reciprocally mounted within said housing.

10. The power tool guide of claim 9, wherein said tool engagement clamp includes feet that mate within undercuts on said tool plate to retain said tool engagement clamp with respect to said tool plate.

11. The power tool guide of claim 1, wherein said tool engagement clamp includes an alignment protrusion, said alignment protrusion aligns the reciprocating engagement member with said housing.

12. The power tool guide of claim 9, wherein said reciprocating engagement member includes a front face to facilitate engagement with the tool.

13. The power tool guide of claim 9, wherein said reciprocating engagement member includes drive key and a control rod, said drive key is mounted to said control rod.

14. The power tool guide of claim 13, wherein said reciprocating engagement member includes a cavity, said drive key includes a raised surface positioned within said cavity, said control rod is adapted to rotate said drive key within said cavity to reciprocate the reciprocating engagement member with respect to housing.

15. The power tool guide of claim 1, wherein said lock plate includes serrations;
said tool plate includes mating serrations.

16. The power tool guide of claim 15, wherein said lock plate includes biasing members to bias said serrations and mating serrations into engagement.

17. The power tool guide of claim 16, wherein said biasing members are coil springs.

18. The power tool guide of claim 14, further a including handle pivotally attached to the free end of said control rod, said handle includes a cam surface, when said handle is rotated, said cam surface engages said housing to reciprocate said control rod and raise and lower said lock plate,
whereby, when said handle is raised, said control rod reciprocates raising said lock plate to disengage said serrations from said mating serrations allowing said clamp to move with respect to said tool plate.

19. A power tool guide comprising:
a tool plate adapted to receive a power tool, said plate having a power tool engagement clamp adapted to engage a power tool and connect the power tool to said tool plate;
said tool engagement clamp includes a housing that moves with respect to said tool plate;
a shoe pad reciprocally mounted within said housing adapted to engage the tool; and
a locking pad adapted to engage the tool plate to lock the tool engagement clamp with respect to said tool plate.

20. The power tool guide of claim 19, further including a locking handle for controlling said shoe pad and the locking pad, said handle is attached to a rod that extends through said shoe pad, said rod has a distal end and a proximal end, said distal end of said rod is threaded and received within a treaded cavity in said locking pad wherein said handle is rotated, said locking pad in a raised position or a lowered position, said raised position allows said power tool engagement clamp to move with respect to said plate, and when in said lowered position, said power tool engagement clamp is locked with respect to said tool plate.

21. The power tool guide of claim 20, further including a cam mounted on said rod for rotation with said rod;
said shoe pad includes an oblong cavity defined by walls, said cam is mounted within said oblong cavity in said shoe pad, rotation of said handle causes said cam to engage said walls of said cavity to force said shoe pad into and out of said housing,
whereby said handle is rotated to move said shoe pad against the shoe while simultaneously forcing said locking pad against said tool plate to lock said power tool engagement clamp against said plate.

22. The power tool guide of claim 19, wherein said tool plate includes a pair of undercuts, said housing includes a pair of wedges, said wedges mate with said pair of undercuts to provide precise movement of said power tool engagement clamp with respect to said tool plate.

23. The power tool guide of claim 22, wherein said tool plate includes a first serrated surface and said locking pad includes a second serrated to mate with said first serrated surface to provide a positive lock between said locking pad and said tool plate.

24. The power tool guide of claim 19, wherein said tool engagement clamp includes feet that mate within undercuts on said tool plate to retain said tool engagement clamp with respect to said tool plate.

25. The power tool guide of claim 19, wherein said tool engagement clamp includes an alignment protrusion, said alignment protrusion aligns the reciprocating engagement member with said housing.

26. The power tool guide of claim 19, wherein said reciprocating engagement member includes a front face to facilitate engagement with the tool.

27. The power tool guide of claim 19, wherein said reciprocating engagement member includes drive key and a control rod, said drive key is mounted to said control rod.

28. The power tool guide of claim 27, wherein said reciprocating engagement member includes a cavity, said drive key includes a raised surface positioned within said cavity, said control rod is adapted to rotate said drive key within said cavity to reciprocate said reciprocating engagement member with respect to said housing.

29. The power tool guide of claim 19, wherein said lock plate includes serrations;
said tool plate includes mating serrations.

30. The power tool guide of claim 29, wherein said lock plate includes biasing members to bias said serrations and mating serrations into engagement.

31. The power tool guide of claim 30, wherein said biasing members are coil springs.

32. The power tool guide of claim 19, wherein said tool plate includes opposed channels and a control lock;
a support base having opposed guide rails, each of said guide rails having first and second ends, said tool plate opposed channels being removably mounted upon said support base opposed guide rails between said first and second ends, said channels allowing said plate to slide upon said opposed guide rails,
said control lock locking said tool plate with respect to said support base at a desired position along said opposed guide rails a spaced distance from said first and second ends,
said support base having an edge extending from at least one of said guide rails adjacent one of said first and second ends, said edge being adapted to engage a side of the workpiece and to slide along the side of the workpiece;
whereby said tool plate is positioned upon said support base, said tool plate is locked a spaced distance from said first and second ends, said support base is then moved along said workpiece with the tool positioned a spaced distance from the side of the workpiece.

33. The power tool guide of claim 32, further a including handle pivotally attached to said control rod, said handle includes a cam surface, when said handle is rotated, said cam surface engages said housing to reciprocate said control rod and raise and lower said lock plate;
whereby, when said handle is raised, said control rod reciprocates raising said lock plate to disengage said lock plate from said tool plate allowing said clamp to move with respect to said tool plate.

34. The power tool guide of claim 32, wherein said control lock includes a body and a control member mounted for rotation with respect to said body, said control member has control lock teeth;
said guide rails include mating guide teeth that engage with said control lock teeth;
said mating control lock teeth and said guide teeth provide precise adjustment of the tool plate along said guide rails and provide positive locking of the tool plate with said guide rails.

35. The power tool guide of claim 34. wherein the said control lock includes a control wheel and lever, said lever prevents movement of said control wheel when said lever is rotated in one direction and allows rotation of said wheel when said lever it is rotated in the opposite direction;
said wheel is locked when said wheel is raised into engagement said body, preventing rotation of the wheel, said wheel is unlocked when disengaged from said body allowing rotation of said wheel and sliding movement of said tool plate on said rails.
